(19) United States
(12) Patent Application Publication
(10) Pub. No.: US 2015/0239358 A1
(43) Pub. Date: Aug. 27, 2015

(54) SYSTEM FOR CHARGING A MOTOR VEHICLE BATTERY

(71) Applicant: RENAULT s.a.s., Boulogne-Billancourt (FR)

(72) Inventors: Christophe Ripoll, Chevreuse (FR); Jerome J. Durand, Paris (FR); Olivier Reyss, Montrouge (FR); Christophe Konate, Massy (FR); Etienne Cuiller, Epernon (FR); Olivier Ploix, Villiers Saint Frederic (FR)

(73) Assignee: RENAULT s.a.s., Boulogne-Billancourt (FR)

(21) Appl. No.: 14/431,130

(22) PCT Filed: Sep. 24, 2013
(86) PCT No.: PCT/FR2013/052222

§ 371 Date: Mar. 25, 2015

(30) Foreign Application Priority Data
Sep. 25, 2012 (FR) 1258984

(51) Int. Cl. B60L 11/18

(52) U.S. Cl. CPC B60L 11/1809

(57) ABSTRACT

A system for charging a motor vehicle battery, configured to be connected to a first multiphase power supply network or to a second multiphase or single phase power supply network of which the power is lower than that of the first network, including: a filtering stage including plural capacitors; a first rectifier stage including switches; and an inverter stage configured to be connected to the battery. The charging system includes: a second rectifier stage including plural switches, and configured to be connected between the power supply network and the battery, in parallel with the filtering stage and at least a portion of the first rectifier stage; and a capacitor of which the capacity is lower than that of the capacitors of the filtering stage, connected between two phases or between a phase and a neutral of the second power supply network.

The invention relates to the technical field of charging a motor vehicle battery, in particular charging a traction battery of an electric motor vehicle.

There are charging systems that can be connected to various types of electrical network (different number of phases, variable power).

However, the constraints of each of the networks are not very compatible and it is very difficult to obtain a good energy performance for each type of electrical network.

For example, application FR2943188 discloses a battery charging device comprising a rectifier input stage intended to be connected to a power supply network and an inverter output stage intended to be connected to the battery. The device comprises means for regulating the average current originating from the input stage around a current value prepared from the maximum current supplied by the power supply network and based on a coefficient at least equal to a ratio between the maximum voltage rectified by the input stage and the battery voltage.

This device can operate with a three-phase or single-phase network. But, it does not provide a good performance with a low-power single-phase network. It is all the more detrimental in that most private users of an electric car do not have a three-phase system but are rather connected to a single-phase electrical network the frequency of which is 50 Hz and the voltage 230 V in France for example.

In the light of the foregoing, one aim of the invention is to provide a system for charging a battery that at least partly addresses the aforementioned drawbacks.

In particular, the objective of the invention is to provide a charging system that can operate with a good performance with different electrical networks and in particular with a three-phase network and with a single-phase network.

One aim of the invention is to provide good compatibility with various types of power supply network.

Another aim of the invention is also to increase the energy efficiency of charging systems.

According to a first aspect, the subject matter of the invention is a system for charging a motor vehicle battery, intended to be connected to a power supply network, said power supply network being a first multiphase power supply network or a second multiphase or single-phase power supply network with a power lower than that of the first network, comprising:
a filtering stage comprising a plurality of capacitors;
a first rectifier stage comprising a plurality of switches; and
an inverter stage intended to be connected to the battery.

According to a general feature, the charging system comprises:
a second rectifier stage comprising a plurality of switches, said second rectifier stage being intended to be connected between said power supply network and the battery, in parallel with the filtering stage and at least a portion of the first rectifier stage; and
a capacitor the capacitance of which is lower than that of the capacitors of the filtering stage, connected between two phases or between a phase and a neutral of the second power supply network.

Thus, in addition to the filtering stage and the first rectifier stage dedicated to a multiphase high-power power supply network, the charging system is to be provided with a second rectifier stage and a filtering capacitor. High power here is understood to mean e.g. a power higher than 3 kW and low power e.g. lower than 3 kW.

The filtering stage and the first rectifier stage are dimensioned for a multiphase high-power power supply system. The dimensioning is not optimized for a low-power and/or non-three-phase (e.g. single-phase) power supply system. By connecting in parallel with the rectifier stage and the filtering stage a second rectifier stage and a capacitor more suited to a low-power non-three-phase network, the performance of the charging system is increased when using this power supply network. These two components supplement the rectifier stage and the filtering stage for enabling the processing of the current originating from a low-power non-three-phase network without passing through the filtering stage or the first rectifier stage.

Furthermore, by placing a filtering capacitor of lower value between the two phases or a phase and a neutral of the power supply network, the filtering capacitance of the charging system is reduced, which allows a significant decrease in the reactive current and therefore an increase in the power factor.

According to one embodiment, the switches of the second rectifier stage comprise electronic components dimensioned for the second power supply network.

The components of the second rectifier stage may, for example, be dimensioned for a power supply network the power of which is lower than 3 kW.

For drawing the current with a rectifier on a high-power electrical network, switches consisting of two semiconductor cells must be provided. Since the second rectifier stage is dedicated to drawing current on a low-power and/or single-phase electrical network, it is no longer necessary to use two semiconductor cells. By using the second rectifier stage switches dimensioned for a low power, conduction losses can be reduced.

Thus, for example, in choosing for the second rectifier stage switches e.g. MOSFET or IGBT transistors (terms well known to those skilled in the art) consisting of a single cell, conduction losses can easily be reduced which are proportional to the value of the current flowing through the rectifier stage. The gain in performance due to this reduction in conduction losses is even more significant in that when the power of the network is low, the ratio between the value of the current flowing through the rectifier stage and the value of the current of the electrical network increases.

According to one embodiment, the second rectifier stage comprises two branches, the first branch being connected to a phase of the second power supply network and the second branch being connected to the neutral of the second power supply network.

The charging system can thus be used with a single-phase network.

According to one embodiment, the second rectifier stage comprises two branches, the first branch being connected to a first phase of the second power supply network and the second branch being connected to a second phase of the second power supply network.

The charging system can thus be used with a two-phase network.

According to another embodiment, the first branch of the second rectifier stage is connected to a phase of the second power supply network via one of the capacitors of the filtering stage.

This branching is advantageous since given the law for calculating the resultant capacitance of two capacitors in series, the resultant capacitance is further reduced compared with that of the lower capacitance capacitor.

According to a further embodiment, the second rectifier stage comprises at least two branches, the first branch of which is formed by a branch of the first rectifier stage.

Thus, it is no longer necessary to use four switches and two branches for creating the second rectifier stage. This enables cost savings.

According to one embodiment, the charging system comprises a switching means configured for switching the current of the first power supply network to the filtering stage and the first rectifier stage and for switching the current of the second power supply network to the second rectifier stage.

Thus the current can be switched from the first power supply network to a rectifier stage dedicated to a low-power single-phase network.

For determining whether the connected power supply network is a first or a second power supply network, the charging system may be provided with a means of measuring the power of the connected power supply network and of determining the number of phases of the power supply network. According to one embodiment, when the power is lower than a certain threshold (e.g. 3 kW) and the number of phases determined is strictly less than 3, then it is determined that the connected power supply network is a second power supply network. On the contrary, if one of these two conditions is not fulfilled it is determined that the connected power supply network is a first power supply network.

According to a feature of this embodiment, the switching means comprises:
a switch intended to be connected in series with said power supply network and the filtering stage, said switch taking the ‘on’ state when the first power supply network is connected and taking the ‘off’ state when the second power supply network is connected; and
the switches of the second rectifier stage, said switches taking the ‘off’ state when the first power supply network is connected and taking the ‘on’ state when the second power supply network is connected.

According to another feature of this embodiment, the switching means comprises:
a portion of the switches of the first rectifier stage, said portion of the switches of the first rectifier stage taking the ‘off’ state when the second power supply network is connected; and
a portion of the switches of the second rectifier stage, said portion of the switches of the second rectifier stage taking the ‘off’ state when the first power supply network is connected.

It is then no longer necessary to have a dedicated switch for switching, the switches of the first and of the second rectifier stage are reused.

Other features and advantages of the invention will emerge on scrutiny of the detailed, non-restrictive description of an embodiment, and the accompanying drawings in which:

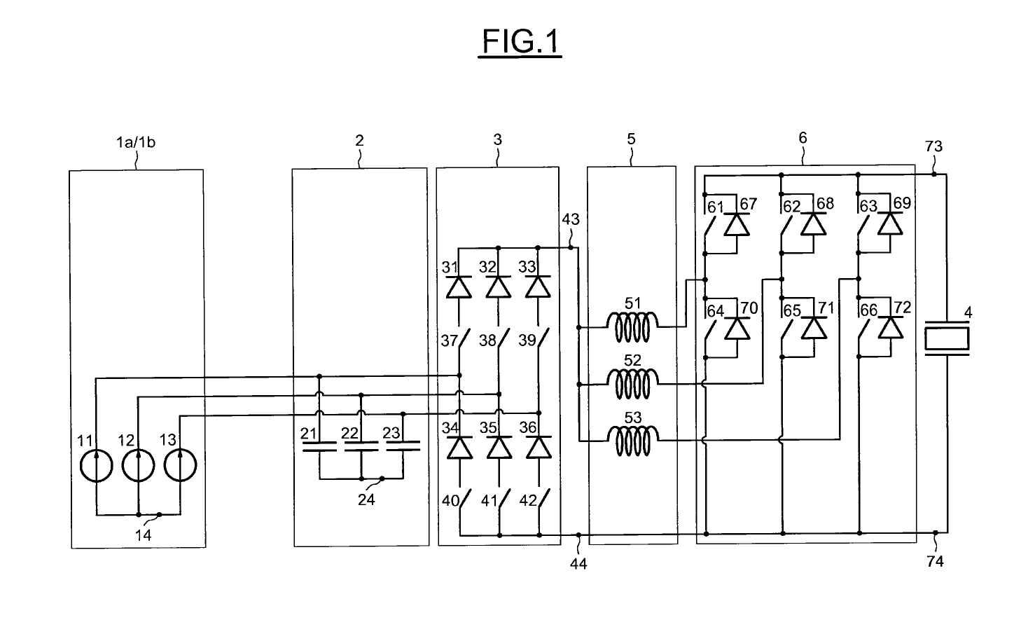

FIG. 1 schematically illustrates a system for charging a battery according to the prior art; and

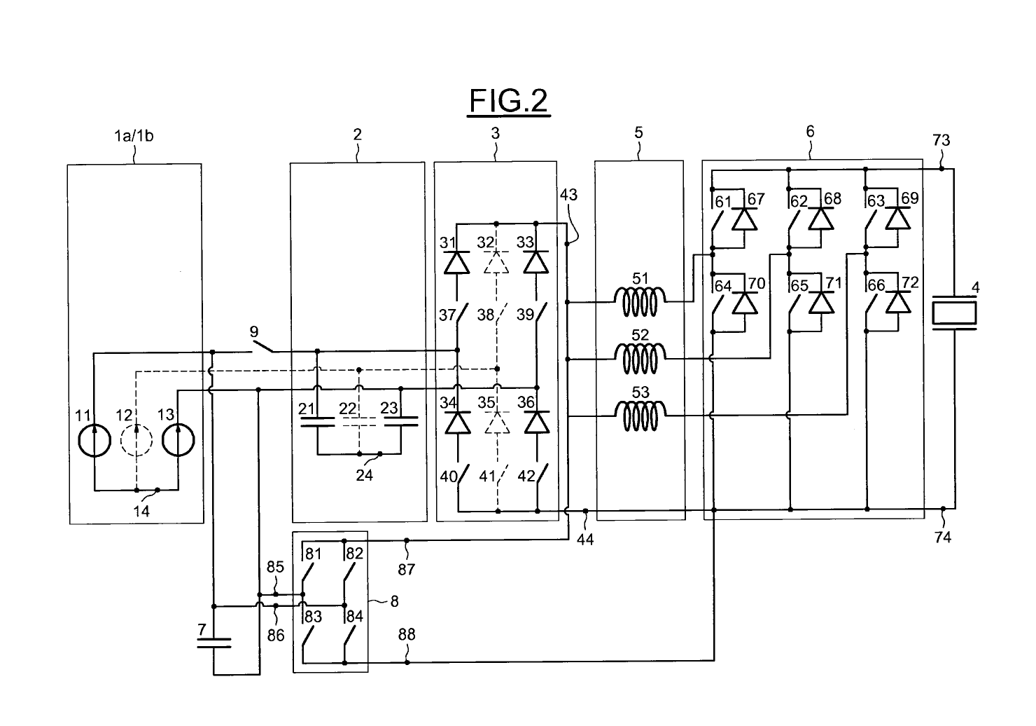

FIGS. 2 to 4 illustrate various embodiments of systems for charging a battery according to the invention.

FIG. 1 illustrates a system for charging a motor vehicle battery 4. This charging system comprises a filtering stage 2, a rectifier stage 3, an inductive stage 5 and an inverter stage 6. The charging system is intended to be connected via the filtering stage 2 to a power supply network 1a/1b. This power supply network may be a first multiphase high-power (higher than 3 kW) power supply network 1a or a second single-phase or multiphase low-power (lower than 3 kW) power supply network 1b. The charging system is represented connected to the power supply network 1a. The power supply network 1a represented here comprises three phases 11, 12 and 13 and a neutral 14. The power supply network 1b not represented is, for example, a single-phase network comprising a phase 13 and a neutral 14. The charging system is also intended to be connected to the battery 4 via the inverter stage 6. All of the filtering 2, rectifier 3, inductive 5 and inverter 6 stages are connected in series and in this order between the power supply network 1a/1b and the battery 4.

The filtering stage 2 consists of three capacitors 21, 22 and 23, one for each of the phases of the power supply network, connected between each of the phases 11, 12 and 13 and the neutral 24 in a star connection. The filtering stage 2 is used to filter the voltage drawn from the connected power supply network so that the current pulses generated by the rectifier stage and the inverter stage are absorbed. Indeed, the current absorbed on the network must satisfy connection constraints imposed by the electrical network operators.

The rectifier stage 3 consists of three branches, one for each of the phases of the power supply network.

The first branch is connected to the phase 11 of the power supply network 1a. The first branch comprises in an upper portion, a switch 37 connected in series with a diode 31 and in a lower portion, a diode 34 connected in series with a switch 40.

The second branch is connected to the phase 12 of the power supply network 1a. The second branch comprises in an upper portion, a switch 38 connected in series with a diode 32 and in a lower portion, a diode 35 connected in series with a switch 41.

The third branch is connected to the phase 13 of the power supply network 1a. The third branch comprises in an upper portion, a switch 39 connected in series with a diode 33 and in a lower portion, a diode 36 connected in series with a switch 42.

The upper portions of the three branches of the rectifier stage 3 meet in a first output terminal 43 of the rectifier stage 3. Similarly, the lower portions of the three branches meet in a second output terminal 44 of the rectifier stage 3. The terminal 44 is intended to be connected to the battery 4. Whereas the terminal 43 is connected to the inductive stage 5.

The inductive stage 5 comprises three coils 51, 52 and 53 connected at the input on the output terminal 43. These coils are those of the stator of the motor vehicle's electric motor. They are reused for providing inductive filtering during battery charging without adding additional components. The charging system is thus integrated into the motor vehicle.

The inverter stage 6 comprises three branches. Each of the three coils 51, 52 and 53 is connected at the output on a branch of the inverter stage 6.

The first branch of the inverter stage 6 is connected to the coil 51 of the inductive stage 5. The first branch comprises in an upper portion, a switch 61 connected in parallel with a diode 67 and in a lower portion, a switch 64 connected in parallel with a diode 70.

The second branch of the inverter stage 6 is connected to the coil 52 of the inductive stage 5. The second branch comprises in an upper portion, a switch 62 connected in parallel with a diode 68 and in a lower portion, a switch 65 connected in parallel with a diode 71.

The third branch of the inverter stage 6 is connected to the coil 53 of the inductive stage 5. The third branch comprises in an upper portion, a switch 63 connected in parallel with a diode 69 and in a lower portion, a switch 66 connected in parallel with a diode 72.

The upper portions of the three branches of the inverter stage 6 meet in a first output terminal 73 of the inverter stage 6. The terminal 73 is intended to be connected to a first terminal of the battery 4.

The lower portions of the three branches meet in a second output terminal 74 of the inverter stage 6. The terminal 74 is connected to the terminal 44 and is intended to be connected to a second terminal of the battery 4.

The ‘on’ and ‘off’ states of each of the switches 37-42 of the rectifier stage 3 and of each of the switches 61-66 of the inverter stage 6 are controllable for controlling the voltage and current drawn from the connected power supply network (1a, 1b) and supplied to the battery 4.

One of the problems of charging systems such as that illustrated in FIG. 1 is that the filtering stage 2 and the rectifier stage 3 are dimensioned for the first power supply network 1a which is a high-power three-phase network. This dimensioning penalizes energy efficiency when this charging system is used with the second network 1b. Yet the second network 1b corresponds to the single-phase network to which individuals are usually connected, e.g. the 230 Volt/50 Hz single-phase network in France.

This reduction in energy efficiency is due to a physical phenomenon known in itself. Any system powered by an AC network draws an apparent electrical power from this network. This apparent electrical power consists of an active power which will actually be used by the electrical system and a reactive power which cannot be used and which is transported by a reactive current out of phase with the active power. For describing the relationship between apparent, active and reactive power, a factor called ‘cos phi’ is used, well known to a person skilled in the art. This factor lies between 0 and 1 and when its value approaches the value 1, the active power approaches the apparent power taken from the network.

Thus, the use of the capacitors 21, 22 and 23 of the filtering stage dimensioned for the first electrical network 1a with the second power supply network 1b produces a significant reactive current. The ‘cos phi’ with the second power supply network 1b is of the order of 0.8. The charging time of the battery 4 is then increased by 20% compared with the ideal case of a ‘cos phi’ equal to 1.

Similarly, the branches of the rectifier stage 3 are dimensioned for a high power with a unidirectional topology that compensates for the ‘cos phi’ in the case of the first power supply network 1a. Thus, two semiconductor cells are used for each switch. The conduction losses for each switch 37-42 are then equal to those of the inductive stage current flowing through two semiconductors. These losses are therefore proportional to the current of the inductive stage 5.

However, when at high power the current of the inductive stage 5 is a value close to that of the current drawn from the power supply network 1a, at low power in single phase, the current of the inductive stage 5 is ten times higher than the current drawn from the power supply network 1b. Thus, the ratio between the conduction losses and the apparent power is, with a single-phase low-power (less than 3 kW) electrical network like the second power supply network 1b, ten times higher than with a three-phase high-power electrical network like the first power supply network 1a. The conduction losses in the cut-out switches 37-42 of the rectifier stage 3 then play a large part in the overall performance of the charging system.

FIG. 2 illustrates a system for charging a battery aimed at solving these problems of energy efficiency in the case of using a non-three-phase and/or low-power network.

The charging system in FIG. 2 like that in FIG. 1 is intended to be connected to a power supply network 1a/1b. This power supply network may be a first multiphase high-power (higher than 3 kW) power supply network 1a or a second single-phase or multiphase low-power (lower than 3 kW) power supply network 1b.

The power supply network 1b here comprises two active phases 11 and 13. The power supply network 1b and the portions of the charging system concerned are represented here in solid lines.

The power supply network 1a here comprises three active phases 11, 12 and 13. The power supply network 1a and the portions of the charging system concerned are represented in FIG. 2 both as solid lines and as dotted lines.

In addition to stages 2, 3, 5, and 6 similar to those described above, the charging system comprises a switch 9 connected in series between the phase 11 of the connected power supply network 1a/1b and the first branch of the rectifier stage 3 before the connection point of the capacitor 21. It also comprises a capacitor 7 connected between the phase 11 and the phase 13 and a second rectifier stage 8 having two terminals 85 and 86 respectively connected to the phase 11 and the phase 13.

The connections of the capacitor 7 and the second rectifier stage 8 and the switch 9 are illustrated here in the case of a power supply network 1b with two active phases 11 and 13. A person skilled in the art would be able to easily adapt these connections in the case of a second power supply network 1b with two other active phases from the phases 11, 12, 13 or in the case of a second power supply network 1b with one of the phases 11, 12, 13 active and a connection to the neutral 14.

The capacitor 7 is connected between the phases 11 and 13 and the value of the charging system capacitance seen by the power supply network 1b corresponds to the capacitance of the capacitor 7. This capacitor 7 is used to filter the voltage drawn from the connected power supply network so that the current pulses generated by the second rectifier stage and the inverter stage are absorbed.

Furthermore, the capacitor 7 has a capacitance less than the capacitances of the capacitors 21, 22 and 23. For example, the capacitance of the capacitor 7 is ten times smaller than the capacitance of each of the capacitors 21, 22 and 23. Thus the value of the reactive current drawn from the power supply network is further reduced.

The second rectifier stage 8 comprises two branches. The first branch is connected via the terminal 85 to the phase 13 of the power supply network 1b. The first branch comprises in an upper portion, a switch 81 and in a lower portion, a switch 83. The second branch is connected via the terminal 86 to the phase 11 of the power supply network 1b. The second branch comprises in an upper portion, a switch 82 and in a lower portion, a switch 84. The upper portions of the two branches of the rectifier stage 8 meet in a first output terminal 87 of the rectifier stage 8. Similarly, the lower portions of the two branches meet in a second output terminal 88 of the rectifier stage 8. The terminal 87 is connected to the terminal 43 of the first rectifier stage 3. Whereas the terminal 88 is connected to the terminal 44 of the first rectifier stage 3. According to one embodiment, the switches (81-84) of the second rectifier stage 8 are dimensioned for a low-power single-phase network. For this, the switches, e.g. diodes, transistors of the MOSFET (Metal Oxide Semiconductor Field Effect Transistor according to a term well known to those skilled in the art) or IGBT (Insulated Gate Bipolar Transistor according to a term well known to those skilled in the art) type, are produced using a single semiconductor cell for a switch. Conduction losses are thus reduced.

The second rectifier stage 8 is thus connected in parallel with the assembly constituted by the switch 9, the filtering stage 2 and the first rectifier stage 3.

The on or ‘off’ states of the switch 9 and the switches of the second rectifier stage 8 are controllable according to the connected network (1a, 1b).

More precisely, when the power supply network 1a is connected i.e. for example when the connected power supply network is multiphase or is single-phase with an electrical power higher than a given threshold (e.g. 3 kW), the switch 9 takes the ‘on’ state and the switches 81-84 of the second rectifier stage 8 take the ‘off’ state. Thus, first, the current from the power supply network 1a goes on after filtering by the filtering stage 2 to flow through the rectifier stage 3. And secondly, the current of the power supply network 1a which is directed toward the second rectifier stage 8 is turned off by the switches 81-84. In addition, given the connection of the capacitor 7 in parallel with the capacitors 21, 22 and 23, and the fact that the value of the capacitance of the capacitor 7 is lower than that of the capacitors 21, 22 and 23, the resultant capacitance seen by the power supply network 1a remains of the order of that of the capacitors 21, 22 and 23.

When the power supply network 1b is connected i.e. for example when the connected power supply network is single-phase with an electrical power lower than said given threshold (e.g. 3 kW), the switch 9 takes the ‘off’ state and the switches 81-84 of the second rectifier stage 8 are ordered to draw a certain voltage and a certain current from the power supply network 1b. Thus, the current from the power supply network 1b cannot flow through the filtering stage or the rectifier stage 3, it is directed directly toward the second rectifier stage 8. Moreover, with the capacitor 7 of a capacitance value e.g. ten times lower than those of the capacitors 21-23, connected between the two phases 11 and 13, the value of the reactive current transmitted on the power supply network 1b is further reduced.

The switch 9 and second rectifier stage 8 assembly thus forms a switching means configured for switching the current of the first power supply network 1a to the filtering stage 2 and the first rectifier stage 3 and for switching the current of the second power supply network 1b to the second rectifier stage 8.

For determining whether the connected power supply network is type 1a or type 1b, the charging system may be provided with a means of measuring the power of the connected power supply network and of determining the number of phases of this power supply network.

According to one embodiment with this means of measurement and determination, when the power is lower than a certain threshold (e.g. 3 kW) and the number of phases determined is strictly less than 3, then it is determined that the connected power supply network is a power supply network of the second type 1b. On the contrary, if one of these two conditions is not fulfilled it is determined that the connected power supply network is a power supply network of the first type 1a.

In addition, as in the charger illustrated in FIG. 1, the ‘on’ or ‘off’ states of each of the switches of the inverter stage 6 (61-66) and of the rectifier stage 3 (37-42) are controllable for controlling the voltage and current drawn from the power supply network 1a and supplied to the battery 4.

Thus a versatile charger is obtained which can operate in good performance conditions with a three-phase network or with another less powerful network comprising fewer phases.

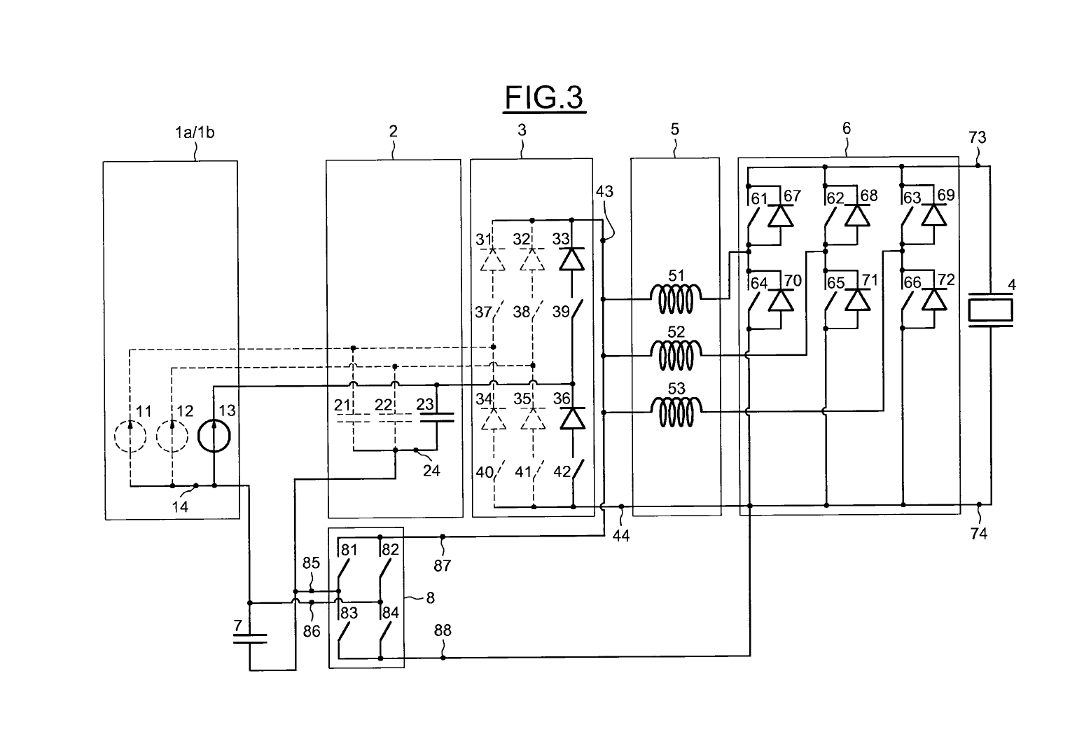

FIG. 3 illustrates another embodiment of a battery charging system.

The charging system in FIG. 3 like that in FIG. 2 is intended to be connected to a power supply network 1a/1b.

The power supply network 1b here comprises one active phase 13 and a neutral 14. The power supply network 1b and the portions of the charging system concerned are represented here in solid lines.

The power supply network 1a here comprises three active phases 11, 12 and 13. The power supply network 1a and the portions of the charging system concerned are represented in FIG. 3 both as solid lines and as dotted lines.

The charging system illustrated in FIG. 3 differs from that in FIG. 2 in that the terminal 86 of the second rectifier stage 8 is connected to the neutral 14 of the power supply network, in that the terminal 85 of the second rectifier stage 8 is connected via the capacitor 23 of the filtering stage 2 to the phase 13 and in that the capacitor 7 is connected between the two terminals 85 and 86 of the second rectifier stage 8. The charging system no longer comprises a switch 9.

The connections of the capacitor 7 and the second rectifier stage 8 are illustrated here in the case of a second power supply network 1b with one active phase 13 and a neutral 14. A person skilled in the art will be able to easily adapt these connections in the case of a second power supply network 1b with another active phase from the phases 11 and 12.

With the new connection of the capacitor 7, the capacitance of the charging system seen by the power supply network 1b is equal to the resultant capacitance of the capacitor 7 in series with the capacitor 23. According to the law for combining capacitors, the inverse of the resultant capacitance is equal to the sum of the inverse of the capacitance of the capacitor 7 with the inverse of the capacitance of the capacitor 23. Thus, assuming that the capacitance of the capacitor 7 is ten times smaller than the capacitance of the capacitor 23, the resultant capacitance is eleven times less than the capacitance of the capacitor 23. Thus the value of the reactive current transmitted on the power supply network 1b is further reduced. The capacitor 7 in series with the capacitor 23 is used to filter the voltage drawn from the connected power supply network 1b so that the current pulses generated by the second rectifier stage and the inverter stage are absorbed.

The ‘on’ or ‘off’ states of the switches 37-42 of the first rectifier stage 3 and of the switches 81-84 of the second rectifier stage 8 are controllable according to the connected network (1a, 1b).

More precisely, when the power supply network 1a is connected i.e. for example when the connected power supply network is multiphase or is single-phase with an electrical power higher than a given threshold (e.g. 3 kW), the switches 37-42 of the first rectifier stage 3 are ordered to draw a certain voltage and current from the power supply network 1a and the switches 81-84 of the second rectifier stage 8 take the ‘off’ state. Thus, first, the current from the power supply network 1a goes on after filtering by the filtering stage 2 to flow through the rectifier stage 3. And secondly, the current of the power supply network 1a which is directed toward the second rectifier stage 8 is turned off by the switches 81-84.

When the power supply network 1b is connected i.e. for example when the power supply network 1b is single-phase with an electrical power lower than said given threshold (e.g. 3 kW), the switches of the first rectifier stage 3 take the ‘off’ state and the switches 81-84 of the second rectifier stage 8 are ordered to draw a certain voltage and a certain current from the power supply network 1b. Thus, the current from the power supply network 1b cannot flow through the filtering stage 3, it is directed directly toward the second rectifier stage 8. Moreover, with the capacitance seen by the electrical network 1b eleven times lower than those of the capacitors 21-23, the value of the reactive current transmitted on the power supply network 1b is further reduced.

The first rectifier stage 3 and second rectifier stage 8 assembly thus forms a switching means configured for switching the current of the first power supply network 1a to the filtering stage 2 and the first rectifier stage 3 and for switching the current of the second power supply network 1b to the second rectifier stage 8.

For determining whether the connected power supply network is type 1a or type 1b, in an identical manner to the charging system described in FIG. 2, the charging system may be provided with a means of measuring the power of the connected power supply network and of determining the number of phases of this power supply network. Using this means of measurement and determination, a first or a second power supply network may then be determined in a manner identical to that of the charging system illustrated in FIG. 2.

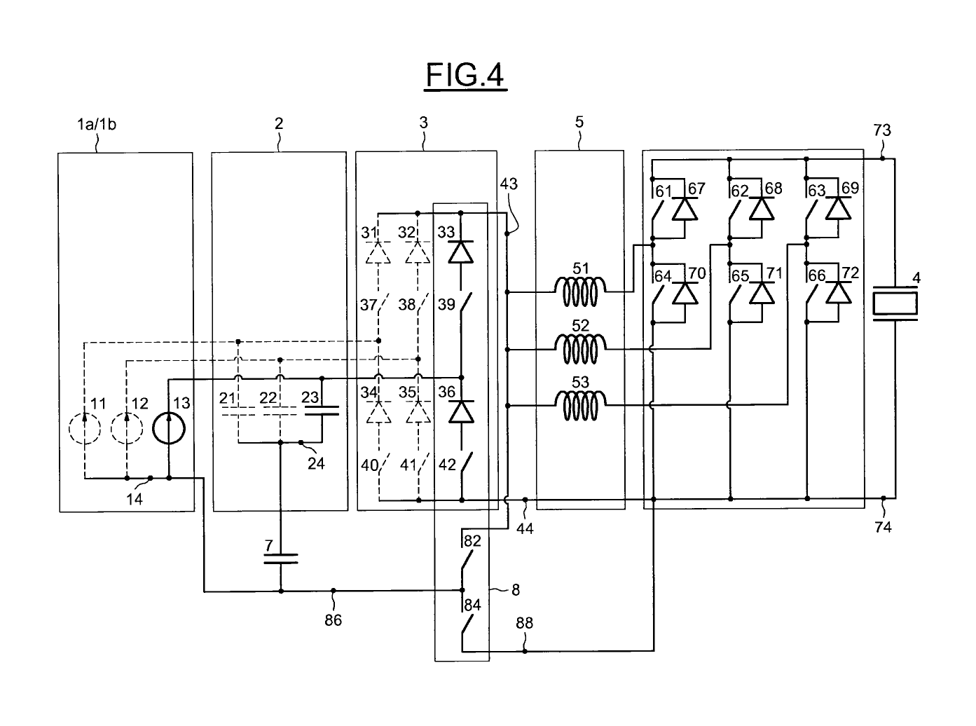

FIG. 4 illustrates another embodiment of a battery charging system.

The charging system in FIG. 4 like that in FIG. 2 or 3 is intended to be connected to a power supply network 1a/1b.

The power supply network 1b here comprises one active phase 13 and a neutral 14. The power supply network 1b and the portions of the charging system concerned are represented here in solid lines.

The power supply network 1a here comprises three active phases 11, 12 and 13. The power supply network 1a and the portions of the charging system concerned are represented in FIG. 4 both as solid lines and as dotted lines.

The charging system illustrated in FIG. 4 differs from that in FIG. 3 in that the first branch of the second rectifier 8 is formed by the third branch of the first rectifier stage 3. Thus, the switches 39 and 42 of the first rectifier stage are used to form the switches 81 and 83.

Thus, a second rectifier stage is obtained the conduction losses of which are reduced only for one branch but which is less costly.

In a similar manner to the charging system in FIG. 3, the on or ‘off’ states of the switches 37-42 of the first rectifier stage 3 and of the switches 81-84 of the second rectifier stage 8 are controllable according to the connected network (1a, 1b).

More precisely, when the power supply network 1a is connected i.e. for example when the connected power supply network is multiphase or is single-phase with an electrical power higher than a given threshold (e.g. 3 kW), the switches 37-42 of the first rectifier stage 3 are ordered to draw a certain voltage and current from the power supply network 1a and the switches 82 and 84 of the second rectifier stage 8 take the ‘off’ state. Thus, first, the current from the power supply network 1a goes on after filtering by the filtering stage 2 to flow through the rectifier stage 3. And secondly, the current from the power supply network 1a which is directed toward the second rectifier stage 8 is turned off by the switches 82 and 84.

When the power supply network 1b is connected i.e. for example when the connected power supply network is single-phase with an electrical power lower than said given threshold (e.g. 3 kW), the switches 37, 38, 40, 41 of the first rectifier stage 3 take the ‘off’ state and the switches 82, 84, 39 and 42 of the second rectifier stage 8 are ordered to draw a certain voltage and a certain current from the power supply network 1. Thus, the current from the power supply network only flows through the third branch of the rectifier stage 3. Moreover, with the capacitance seen by the electrical network eleven times lower than those of the capacitors 21-23, the value of the reactive current transmitted on the power supply network 1b is further reduced.

Thus, in a manner similar to the charging system in FIG. 3, the first rectifier stage 3 and second rectifier stage 8 assembly forms a switching means configured for switching the current of the first power supply network 1a to the filtering stage 2 and the first rectifier stage 3 and for switching the current of the second power supply network 1b to the second rectifier stage 8.

For determining whether the connected power supply network is type 1a or type 1b, in an identical manner to the charging system described in FIG. 2 or 3, the charging system may be provided with a means of measuring the power of this connected power supply network and of determining the number of phases of the power supply network. Using this means of measurement and determination, a first or a second power supply network may then be determined in a manner identical to that of the charging system illustrated in FIG. 2 or 3.

1-9. (canceled)

10. A system for charging a motor vehicle battery, configured to be connected to a power supply network, the power supply network being a first multiphase power supply network or a second multiphase or single-phase power supply network with a power lower than that of the first network, and including a filtering stage including a plurality of capacitors, a first rectifier stage including a plurality of switches, and an inverter stage configured to be connected to the battery, the charging system comprising:
a second rectifier stage comprising a plurality of switches, the second rectifier stage configured to be connected between the power supply network and the battery, in parallel with the filtering stage and at least a portion of the first rectifier stage; and
a capacitor with a capacitance lower than that of the capacitors of the filtering stage, connected between two phases or between a phase and a neutral of the second power supply network.

11. The charging system as claimed in claim 10, wherein the switches of the second rectifier stage comprise electronic components dimensioned for the second power supply network.

12. The charging system as claimed in claim 10, wherein the second rectifier stage comprises first and second branches, the first branch being connected to a phase of the second power supply network and the second branch being connected to the neutral of the second power supply network.

13. The charging system as claimed in claim 10, wherein the second rectifier stage comprises first and second branches, the first branch being connected to a first phase of the second power supply network and the second branch being connected to a second phase of the second power supply network.

14. The charging system as claimed in claim 12, wherein the first branch of the second rectifier stage is connected to a phase of the second power supply network via one of the capacitors of the filtering stage.

15. The charging system as claimed in claim 10, wherein the second rectifier stage comprises at least first and second branches, the first branch of which is formed by a branch of the first rectifier stage.

16. The charging system as claimed in claim 10, further comprising a switching means configured for switching current of the first power supply network to the filtering stage and the first rectifier stage and for switching current of the second power supply network to the second rectifier stage.

17. The charging system as claimed in claim 16, wherein the switching means comprises:
a switch configured to be connected in series with the power supply network and the filtering stage, the switch taking an on state when the first power supply network is connected and taking an off state when the second power supply network is connected; and
the switches of the second rectifier stage, the switches taking the off state when the first power supply network is connected and taking the on state when the second power supply network is connected.

18. The charging system as claimed in claim 16, wherein the switching means comprises:
a portion of the switches of the first rectifier stage, the portion of the switches of the first rectifier stage taking an off state when the second power supply network is connected; and
a portion of the switches of the second rectifier stage, the portion of the switches of the second rectifier stage taking the off state when the first power supply network is connected.
